(19) United States
(12) Patent Application Publication
(10) Pub. No.: US 2009/0047821 A1
(43) Pub. Date: Feb. 19, 2009

(54) Electrical connector

(75) Inventors: Li-Sen Chen, Taoyuan Hsien (TW); Hua-Chun Chang, Taoyuan Hsien (TW)

Correspondence Address: Joe McKinney Muncy, PO Box 1364, Fairfax, VA, 22038-1364, US

(73) Assignee: SPEED TECH CORP.

(21) Appl. No.: 12/068,520

(22) Filed: Feb. 7, 2008

(30) Foreign Application Priority Data
Aug. 17, 2007 (TW) 96213743

(51) Int. Cl. H01R 13/627

(52) U.S. Cl. 439/358

(57) ABSTRACT

An electrical connector comprises a locking device, comprising a long sheet body, a pair of locking portions, a tail portion, a fixing portion and an operating portion. The locking portions stretch respectively from both sides of the long sheet body and have locking hooks at each end. The tail portion and the fixing portion stretch out from the middle of the rear edge of the long sheet body, and the operating portion stretches out from the middle of the front edge. The fixing portion is in a U-shape to buckle the locking device to the electrical connector. The tail portion and the fixing portion can keep the locking device in locking state, and by pressing the operating portion to keep the locking device in releasing state.

### RELATED APPLICATIONS

This application claims priority to Taiwan Application Serial Number 96213743, filed Aug. 17, 2007, which is herein incorporated by reference.

### FIELD OF INVENTION

The present invention relates to an electrical connector. More particularly, the present invention relates to a cable end electrical connector.

### DESCRIPTION OF RELATED ART

Refer to FIG. 1. FIG. 1 illustrates a locking device in prior art. The disclosed locking device in U.S. Pat. No. 6,948,965 B2 has a locking component 11 cut from a sheet metal and is assembled in the locking device 10. The locking component 11 cut from a sheet metal requires greater stress for elastic deformation to release, and even the surface for pressing on the operating region 12 is also the cut section of a sheet metal. Therefore, a user has to press the operating region 12 forcefully to exceed the structure elasticity of the tail region 13 to press the hook 14 of the locking component 11 down into the shell 15 to release the locking device 10 from a coupled connector.

Because the volume of the locking component 11 is small, the structure of the locking component 11 requires greater stress for the elastic deformation to release from the coupled connector. Furthermore, the operating region 12 of the locking device 10 is at the cross section of the cut sheet metal, thus it is hard to elastically deform the locking device 10 by pressing the operating region 12 of the locking device 10.

### SUMMARY

The invention presents an electrical connector, wherein the electrical connector has an elastically deformable locking device, and the section for inducing the elasticity is bent from a sheet metal.

The invention presents an electrical connector, linking to a cable, comprising an insulating housing, a terminal set, a shielding shell, and a locking device. The terminal set is inserted in the insulating housing. The shielding shell covers the insulating housing and encloses the end of the cable. The locking device comprises a main body, a tail portion, and a pair of locking hooks, wherein the main body is retained adjacent to one surface of the insulating housing, the tail portion extends out from the main body wherein the end of the tail portion is fastened in the insulating housing, and the locking hooks extend out respectively from the both ends of the main body, and perforates out from the shielding shell. The main body and the tail portion are normally retained certain distance to the insulating housing.

### BRIEF DESCRIPTION OF THE DRAWINGS

The invention can be more fully understood by reading the following detailed description of the embodiment, with reference made to the accompanying drawings as follows:

FIG. 1 illustrates a locking device in prior art.

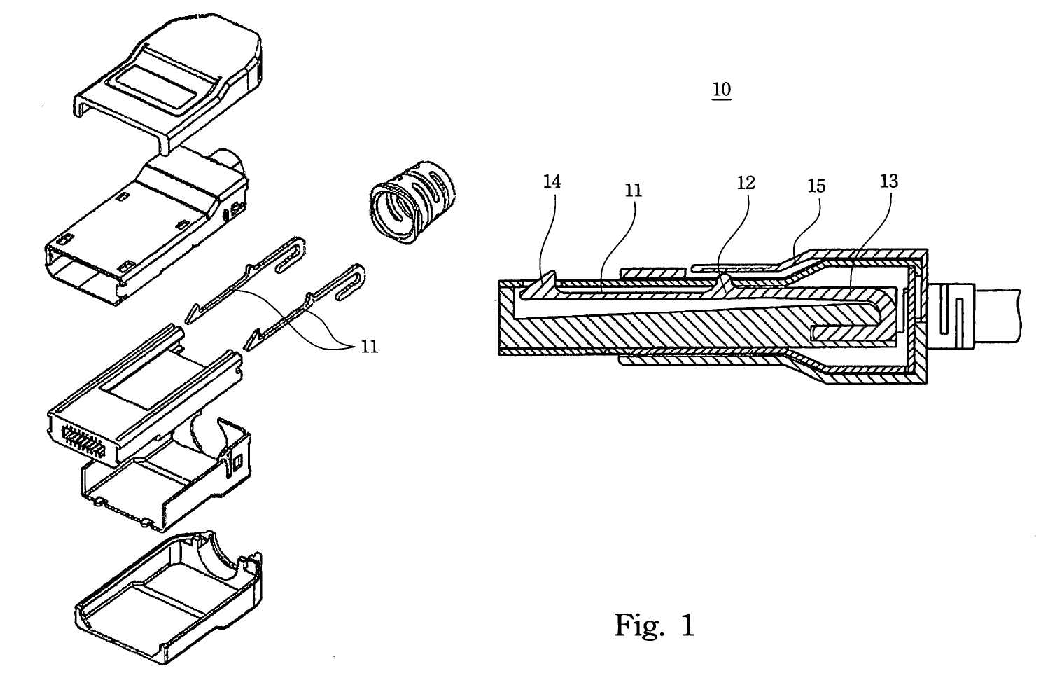

FIG. 2 illustrates the components of the preferred embodiment I of the electrical connector of this invention.

FIG. 3 illustrates the assembly of the insulating housing and the locking device of the preferred embodiment I of the electrical connector of this invention.

FIG. 4 illustrates the appearance of the preferred embodiment I of the electrical connector of this invention.

FIG. 5 illustrates the insulating housing and the locking device of the preferred embodiment II of the electrical connector of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The invention presents an electrical connector, comprising a locking device, links to a cable for signals or electrical power transmission.

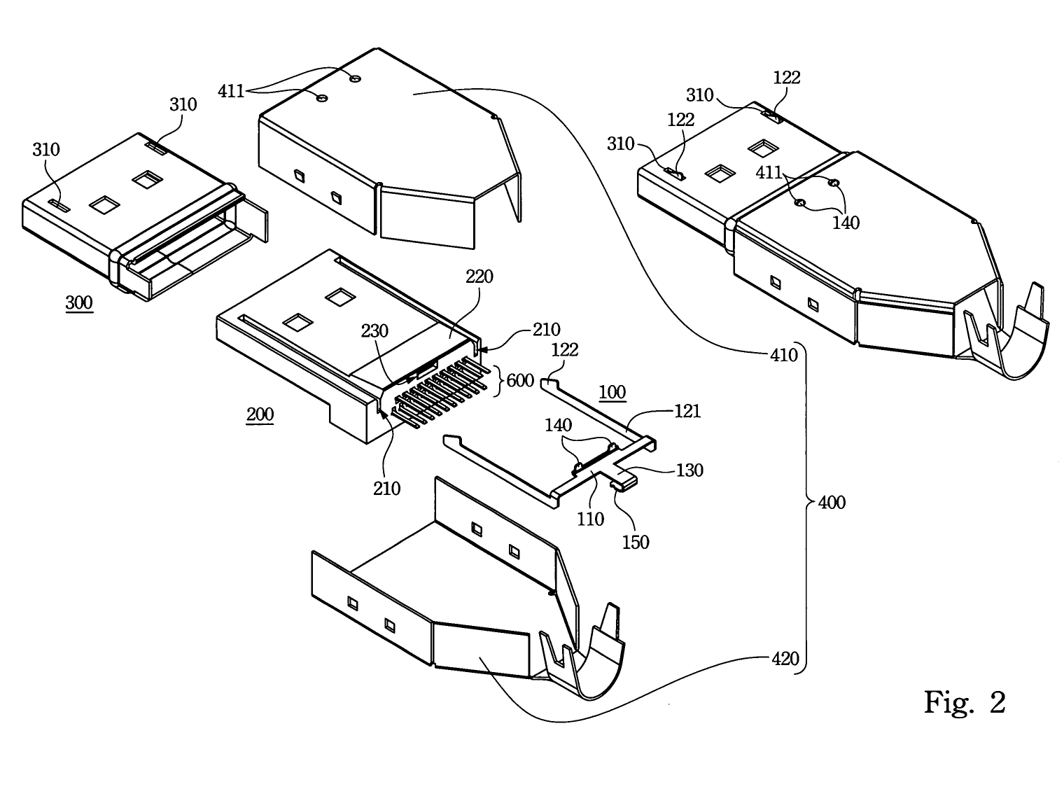

Refer to FIG. 2. FIG. 2 illustrates the components of the preferred embodiment I of the electrical connector of this invention. As shown in FIG. 2, the electrical connector comprises a locking device 100, an insulating housing 200, a shielding shell 400 and a set of terminals 600. In the embodiment I, the insulating housing 200 is roughly a cube shape made of electrically insulating materials. The rear section of the upper surface of the insulating housing 200 has a lifting incline 220. The grooves 210 are disposed on both sides of the insulating housing 200 from the lifting incline 220 to the front section of the upper surface of the insulating housing 200. A fastening trough 230 is disposed on the sidewall at the rear end of the insulating housing 200. The set of terminals 600 disposed in the insulating housing 200 provides a link to a cable and to a coupled electrical device for signal or electrical power transmission. In the embodiment I, the set of terminals 600 are inserted in the plural perforations around the central section in the insulating housing 200. The locking device 100 is disposed on the insulating housing 200. Then, the locking device 100 and the insulating housing 200 are covered in the plug shell 300. More specifically, the plug shell 300 covers the front section of the insulating housing 200 and partially encloses the locking device 100. The above-mentioned shielding shell 400 is composed of the plug shell 300, the upper shielding shell 410 and the lower shielding shell 420. Two locking apertures 310 are disposed on the upper surface of the plug shell 300, and correspond to the above-mentioned grooves 210 respectively. The shielding shell 400 encloses the insulating housing 200 and the set of terminals 600 in the insulating housing 200 for shielding protection of the electrical connector of this invention. The upper shielding shell 410 has at least one opening 411 out of which the operating portion 140 of the locking device 100 protrudes so that users can press the operating portion 140.

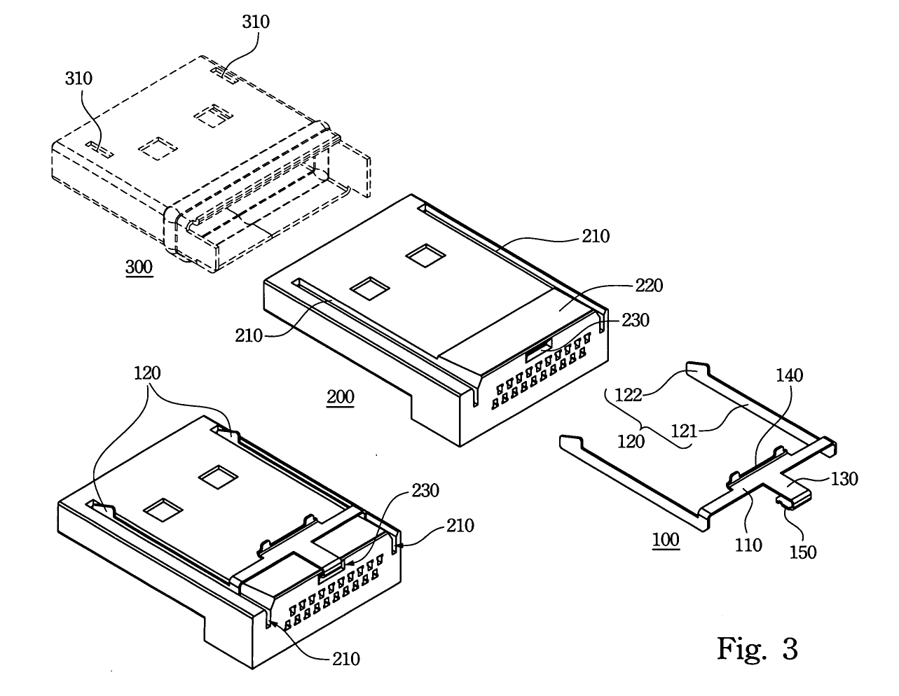

Refer to both FIG. 2 and FIG. 3. FIG. 3 illustrates the assembly of the insulating housing and the locking device of the preferred embodiment I of the electrical connector of this invention. As the above mentions, a lifting incline 220 is disposed at the rear section on the upper surface of the insulating housing 200. The grooves 210 stretch along both sides of the lifting incline 220, and the fastening trough 230 is disposed on the rear sidewall of the insulating housing 200. The locking device 100 is provided to lock the electrical connector to a coupled electrical device, comprises a main body 110, a locking portion 120 and a tail portion 130. The locking portion 120 is bent down from the two ends of the main body 110, and has locking hooks 122 at the frontward end. The locking hooks 122 of the locking device 100 stretch out along the corresponding grooves 210 on the insulating housing 200 toward the coupled electrical device. To lock the connector inside a coupled electrical device, the locking device 100 has the extension shafts 121 between the main body 110 and the locking hooks 122 to lengthen the locking portion 120. More specifically, the extension shafts 121 are placed in the grooves 210 and the locking hooks 122 correspond to the locking apertures 310 on the plug shell 300. Besides, in the opposite direction of the extension shaft 121 is set, a tail portion 130 stretches out from the main body 110. The tail portion 130 fastens the locking device 100 on the insulating housing 200 and retains the normal state of the locking device 100. In the embodiment I, the tail portion 130 is bent over in U-shape from the locking device 100 to form a fastening portion 150. Then, the fastening portion 150 is inserted in the fastening trough 230 on the rear sidewall of the insulating housing 200, to fasten the locking device 100 on the insulating housing 200 and span the main body 110 of the locking device 100 over the lifting incline 220 of the insulating housing 200. The U-shaped crook of the tail portion 130 increases the springiness for the tail portion 130 of the locking device 100. Nevertheless, those skilled in the art can substitute any equivalent structures for the U-shaped crook of this embodiment.

Due to the main body 110 of the locking device 100 spanning over the lifting incline 220 of the insulating house 200, the locking portion 120 may be lifted up to a specific height instead of lying flat on the insulating housing 200. Therefore, the locking hooks 122 at the frontward ends of the locking portions 120 are able to protrude up the locking apertures 310 on the plug shell 300 to retain the locking device 100 in the locking state.

Moreover, in the embodiment I, the front edge of the locking device main body 110 is bent upward to form an operating portion 140. By Pushing the operating portion 140 to press the locking portion 120 down into the insulating housing 200, and drive the locking hook 122 receding downward into the locking apertures 310 as the releasing state of the locking device 100. Because the lifting incline 220 is disposed on the insulating housing 200 upper surface, the slope of the lifting incline 220 can be arranged for pressing the operating portion 140 downward within a specific range. Because the locking device 100 span the lifting incline 220, the tail portion 130 is deformed and pressing down the operating portion 140 induces springiness. The induced springiness ensures the locking hook 122 returns to protruding out from the locking apertures 310 as in the locking state when the operating portion 140 is no longer pressed. Therefore, by the interactions with the locking device 100 and other elements, the locking device can be locked and released from a coupled electrical device.

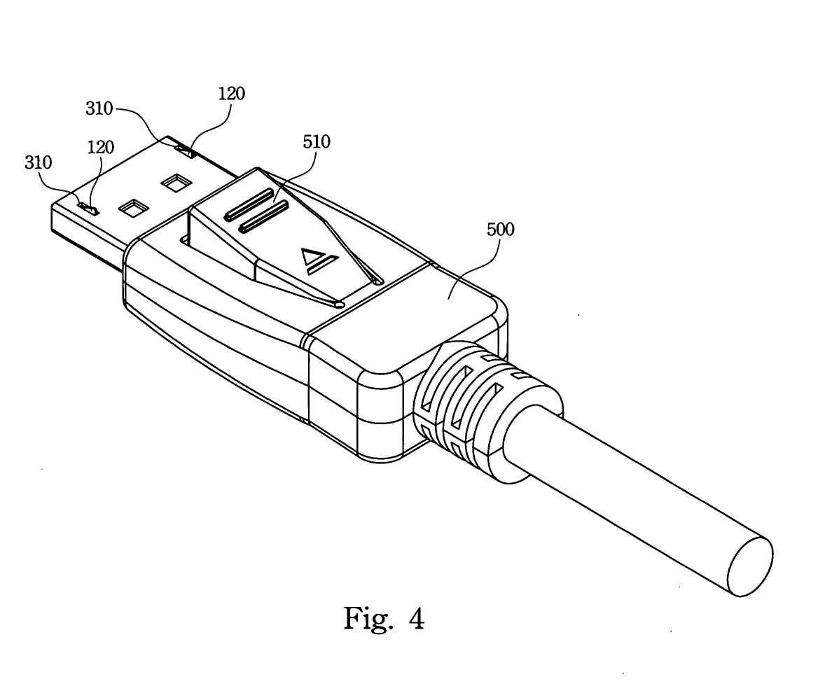

Refer to FIG. 4. FIG. 4 illustrates the appearance of the preferred embodiment I of the electrical connector of this invention. As shown in FIG. 4, the shielding shell 400 is further covered by an outer shell 500. A bottom 510 is disposed corresponding to the operating portion 140 on the outer shell 500. In the embodiment I, the bottom 510 partially connects to the outer shell 500 with a small interval separating the bottom 510 from the outer shell 500. Therefore, the operating portion 140 can be pressed by a user with the outer shell 500 covering the electrical connector. Definitely, those skilled in the art are possible to substitute a pressing membrane forming on the outer shell surface for the bottom of this embodiment.

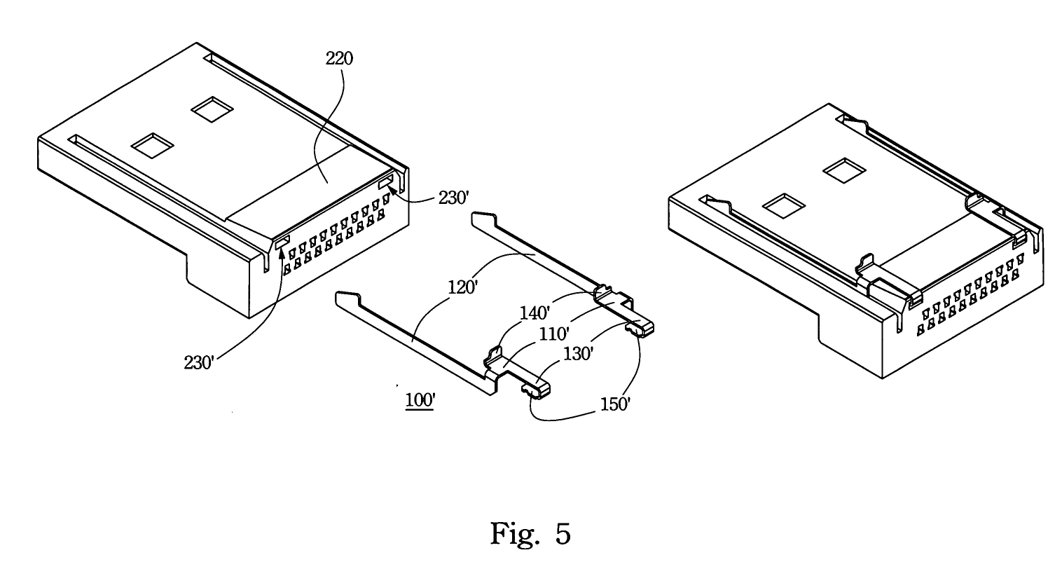

In addition, the locking device of this embodiment is bent from a sheet metal, and then inserted into the fastening trough of the insulating housing to retain and span over the insulating housing. Although the present invention has been described in the embodiment I thereof, the spirit and scope should not be limited to the description of the embodiment contained herein. Those skilled in the art is possible to substitute the locking device for two locking components bent from two pieces of sheet metal, then is inset into the two corresponding fastening troughs of the insulating housing. Refer to FIG. 5. FIG. 5 illustrates the insulating housing and the locking device of the preferred embodiment II of the electrical connector of this invention. Most of the components in the embodiment II are the same as the above-mentioned embodiment I. The difference from the above-mentioned embodiment I is that the two fastening troughs 230′ are disposed on the rear sidewall of the lifting incline 220, and the locking device 100′ with two symmetric locking branches are used. Each of the locking branches has the same components as those in the above-mentioned embodiment I, such as a main body 110′, a locking portion 120′, a tail portion 130′, an operating portion 140′, and a fastening portion 150′, etc.

Furthermore, in those preferred embodiments, the tail portion is designed in U-shaped and inserted in the fastening trough of the insulating housing with the fastening portion as parallel to the linking direction of the connector. Although the present invention has been described in the certain embodiments thereof, the spirit and scope should not be limited to the description of the embodiments contained herein. Those skilled in the art is possible to substitute the L-shaped tail portion for the U-shaped tail portion, and insert the L-shaped tail portion in the fastening trough of the insulating housing as perpendicular to the linking direction of the connector of this invention.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An electrical connector, comprising a terminal set, an insulating housing, a shielding shell and at least a locking device, wherein the terminal set with plural terminals provides for linking to a cable and connecting to a coupled electrical device; the insulating housing provides for fastening terminals of the terminal set in the electrical connector; the shielding shell covers the insulating housing and encloses the cable's end; and the locking device comprises,
a main body, retained adjacent to one surface of the insulating housing;
a tail portion, extending out from the main body wherein the tail portion's end is fastened in the insulating housing; and
a locking hook, extending out from the main body and perforating out from the shielding shell;
wherein the main body and the tail portion are retained certain distance to the insulating housing.

2. The electrical connector of claim 1, wherein the tail portion is U-shaped for retaining the main body of the locking device a distance to the insulating housing.

3. The electrical connector of claim 2, wherein the tail portion's end has a fastening portion, the insulating housing has a fastening trough, and the locking device is fastened onto the insulating housing by the fastening portion intervening with the fastening trough.

4. The electrical connector of claim 1, wherein the locking device, having a shaft between the main body and the locking hook, provides the locking hook stretching into the coupled electric device.

5. The electrical connector of claim 4, wherein the insulating housing has a groove corresponding to the shaft and the locking hook so as to provide a moving space for the shaft and the locking hook.

6. The electrical connector of claim 4, wherein the locking device is divided into a left branch and a right branch symmetrically, being respectively disposed in the grooves on the insulating housing, and both tail portions of the two branches are fastened into the corresponding fastening troughs of the insulating housing.

7. The electrical connector of claim 1, wherein the locking device comprises an operating portion, for moving the locking hook toward the insulating housing by pressing the operating portion.

8. The electrical connector of claim 1, wherein the locking device further comprises an outer shell, covering the shielding shell.
